(19) United States
(12) Patent Application Publication
(10) Pub. No.: US 2017/0142186 A1
(43) Pub. Date: May 18, 2017

(54) METHOD, APPARATUS, AND ELECTRONIC DEVICE FOR DOWNLOADING FILES

(71) Applicants: Le Holdings (Beijing) Co., Ltd., Beijing (CN); LE SHI INTERNET INFORMATION & TECHNOLOGY CORP., BEIJING, Beijing (CN)

(72) Inventors: Dawei XIAO, Beijing (CN); Linhu WANG, Beijing (CN)

(73) Assignees: Le Holdings (Beijing) Co., Ltd., Beijing (CN); LE SHI INTERNET INFORMATION & TECHNOLOGY CORP., BEIJING, Beijing (CN)

(21) Appl. No.: 15/240,395

(22) Filed: Aug. 18, 2016

Related U.S. Application Data
(63) Continuation of application No. PCT/CN2016/085174, filed on Jun. 7, 2016.

(30) Foreign Application Priority Data
Nov. 17, 2015 (CN) 201510794673.3

(51) Int. Cl. H04L 29/08; H04L 12/879

(52) U.S. Cl. CPC H04L 67/06; H04L 67/1097; H04L 49/901

(57) ABSTRACT

The present disclosure provides a method, apparatus and electronic device for downloading files. The method for downloading files comprises: creating a target file for a file to be downloaded, dividing the file to be downloaded into data segments and assigning multiple threads to download the data segments, wherein each data segment has start position information; opening the target file by the multiple threads, and setting file pointers to write positions corresponding to the start position information of the data segments the threads are respectively responsible for downloading; and downloading the data segments and writing the downloaded data segments to the target file starting from the write positions by the multiple threads. The method, apparatus and electronic device for downloading files provided by the embodiments of the present disclosure can download files through multiple threads and write to a target file, which makes downloading smoother and improves download experience for users.

### CROSS-REFERENCE TO RELATED APPLICATIONS

This application is a continuation of International Application No. PCT/CN2016/085174, with an international filing date of filed Jun. 7, 2016, which is based upon and claims priority to Chinese Patent Application No. 201510794673.3, filed on Nov. 17, 2015, the entire contents of all of which are incorporated herein by reference.

### TECHNICAL FIELD

The present disclosure relates to internet technology, more specifically, to a method, apparatus and electronic device for downloading files.

### BACKGROUND

With the increasing advance of internet industry, users can download abundant resources via Internet. For example, more users download network video files to a local machine through a broadband network, and then copy the downloaded video files to removable devices such as a cell phone, PAD and etc. for viewing. Due to users' increasing such demand, downloading technology has been continuously developing, which is categorized into a single-threaded mode and a multi-threaded mode. In order to improve the downloading speed, the multi-threaded mode is typically adopted. Specifically, a file is first divided into a plurality of file segments, and then the file segments are downloaded to the local machine with multiple threads. After all the file segments are downloaded, the file segments are merged into an original file.

However, the above technique has the following disadvantages: the process of file merging takes up a lot of disk input/output resources, and the speed for disk read writing slows down, and the operating system may even sinks into a state of suspension, resulting in a slow downloading speed and poor user experience.

### SUMMARY

The object of the present disclosure is to provide a method, apparatus and electronic device for downloading files, so as to download file quickly and smoothly through multiple threads and write to target file directly, thereby improving downloading experience for users.

According to an aspect of the present disclosure, a method for downloading files is provided, which includes: creating a target file for a file to be downloaded, dividing the file to be downloaded into data segments and assigning multiple threads to download the data segments, wherein each data segment has start position information; opening the target file by the multiple threads, and setting file pointers to write positions corresponding to the start position information of the data segments the threads are respectively responsible for downloading; and downloading the data segments and writing the downloaded data segments to the target file starting from the write positions by the multiple threads.

According to another aspect of the present disclosure, an apparatus for downloading files is provided, which includes: a file assignment module, configured to create a target file for a file to be downloaded, to divide the file to be downloaded into data segments and to assign multiple threads to download the data segments, wherein each data segment has start position information; a pointer setting module, configured to open the target file by the multiple threads, and to set file pointers to write positions corresponding to the start position information of the data segments the threads are respectively responsible for downloading; and a file downloading module, configured to download the data segments and write the downloaded data segments to the target file starting from the write positions by the multiple threads.

According to yet another aspect of the present disclosure, an electronic device is provided, which includes: a memory, configured to store a program; a processor, configured to execute the program stored in the memory, wherein the program causes the processor to execute instructions of the above method for downloading files.

According to yet another aspect of the present disclosure, a computer program is provided, which includes computer readable code, an electronic device executing instructions of the above method for downloading files when the computer readable code is executed on the electronic device.

According to yet another aspect of the present disclosure, a computer readable medium is provided, in which the computer program is stored.

According to the method, apparatus and electronic device for downloading files provided by the embodiments of the present disclosure, multiple threads are respectively responsible for downloading the corresponding data segments of the file to be downloaded respectively, and writing the downloaded data segments to the target file created for the file to be downloaded. Compared with the prior art, the processing of merging a file is spared, and the download process is faster and smoother, thereby improving download experience for users. Furthermore, by distinguishing whether the storage device possesses removability property, the probability of damaging files when removing the removability device is reduced.

It is to be noted that the general descriptions above and the detailed descriptions that follow are merely exemplary and descriptive, and cannot limit the present disclosure.

### BRIEF DESCRIPTION OF THE DRAWINGS

For clarity of descriptions on the embodiments of the present disclosure, accompanying drawings referred to descriptions on the embodiments are briefly introduced below. It is apparent that the accompanying drawings described below merely cover certain embodiments of the present disclosure and that those skilled in the art can obtain, without exerting creative efforts, other drawings from these accompanying drawings.

FIG. 1 is a schematic diagram of an example illustrating the general concept of the present disclosure;

FIG. 2 is a flow chart illustrating a method for downloading files according to a first embodiment of the present disclosure;

FIG. 3 is a logic block diagram illustrating an apparatus for downloading files according to a second embodiment of the present disclosure;

FIG. 4 is a structural diagram illustrating an electronic device according to a third embodiment of the present disclosure.

Particular embodiments of the present disclosure have been shown with reference to the above accompanying drawings, and more detailed descriptions will be given hereinafter. These accompanying drawings and literal descriptions are not intended to limit the scope of the present disclosure concepts by any means, but rather the present disclosure concepts are explained with reference to the particular embodiments for those skilled in the art.

### DETAILED DESCRIPTION

The basic concept of the present disclosure is to provide a technical scheme for downloading files based on a multi-threaded mode and directly writing the downloaded data to a target file, thereby increasing the download speed, making file downloading smoother, and enhancing download experience for users.

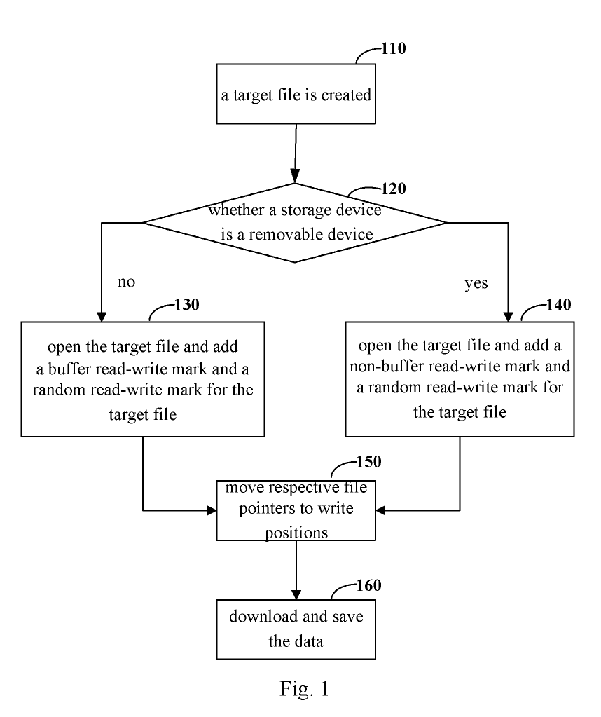

FIG. 1 is a schematic diagram of an example illustrating the general concept of the present disclosure.

Referring to FIG. 1, first in step 110, a target file is created, and an actual length of the target file is set with a call of Windows API (WinAPI), which can save time for the operating system to feed the target file; next, the target file is opened by multiple threads in a shared read-write manner. In the meantime, in step 120, whether a storage device is a removable device is examined. In step 130, if the storage device is not a removable device, a buffer read-write mark and a random read-write mark are added for the target file. In step 140, if the storage device is a removable device, a non-buffer read-write mark and a random read-write mark are added for the target file. Finally, in step 150, the threads move respective file pointers to write positions corresponding to respective start positions of data segments which the threads are responsible for downloading. In step 160, the threads start to download and use corresponding handles to write to the target file.

It can be seen that, during the file download process, a file merging process is not necessary, which avoids massive disk input/output resources being occupied because of the file merging process. Therefore, according to the basic concept of the present disclosure, download speed and download smoothness are improved, and download experience for users is enhanced. In addition, by distinguishing removability characteristics of storage devices, the probability of damaging files is reduced when the removable device is removed.

Hereinafter, the method, apparatus and electronic device for downloading files according to the embodiments of the present disclosure will be described in detail with accompanying drawings.

### Embodiment 1

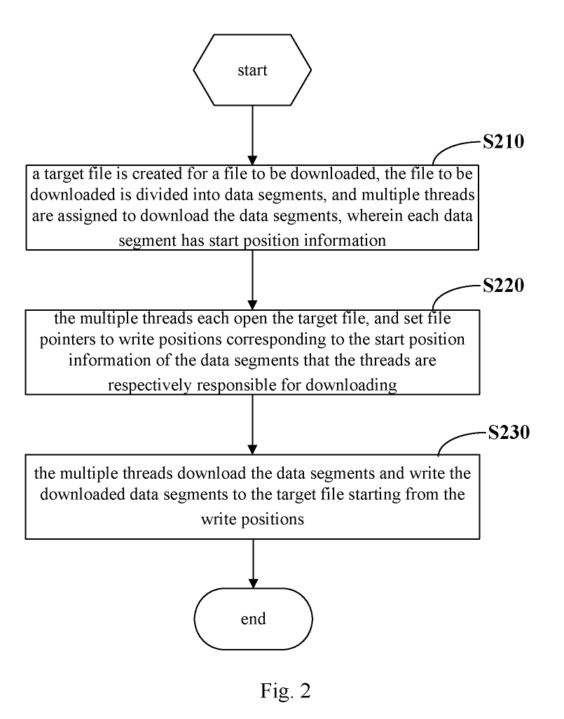

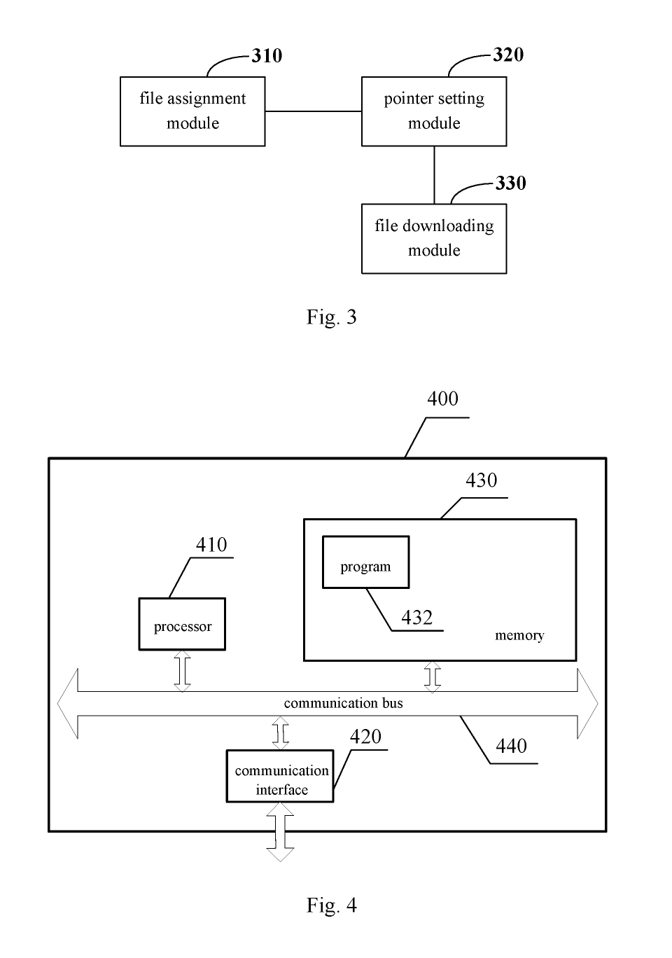

FIG. 2 is a flow chart illustrating a method for downloading files according to a first embodiment of the present disclosure. The method can be implemented by the apparatus of the embodiment shown in the FIG. 3.

Referring to FIG. 2, in step S210, a target file is created for a file to be downloaded, the file to be downloaded is divided into data segments, and multiple threads are assigned to download the data segments, wherein each data segment has start position information.

According to the exemplary embodiment of the present disclosure, in step S210, the processing of creating a target file for a file to be downloaded further includes, setting the size of the created target file to be the same as that of the file to be downloaded.

In a particular implementation, for example, when a user clicks a view button in a video replay interface, a user terminal is instructed to download a multimedia file, wherein the multimedia file is the file to be downloaded. The address of the file to be downloaded can be the Universal Resource Locator (URL) corresponding to the multimedia file, wherein URL is an identification method to thoroughly describe an address of a webpage and other resources on the network. Information included in URL can indicate the address of a file and how the web browser should handle it. Each webpage has a unique name identifier, which is often called URL address. The URL address can be directed to a local disk, or a certain computer on the LAN, but mostly the URL address is a website on the Internet.

The user terminal can send the address of the multimedia file to a server and request the size of the multimedia file from the server, so that the server can obtain the size of the multimedia file from the address of the multimedia file. The user terminal receives the size of the file to be downloaded sent by the server, and then creates a file having the same size with the file to be downloaded in local disk. Then, according to the size of the file to be downloaded, data segments of the file to be downloaded are separately assigned to multiple threads to be responsible for downloading, wherein each data segment has respective start position information.

In step S220, the multiple threads each open the target file, and set file pointers to write positions corresponding to the start position information of the data segments that the threads are respectively responsible for downloading.

Specifically, after the processing of the previous step, the multiple threads can respectively open the target file, and set the respective file pointer to the write positions corresponding to the start position of the data segment that the threads are respectively responsible for downloading.

According to a preferred embodiment of the present disclosure, in step S220, the processing of opening the target file may also include opening the target file in a shared read-write manner. Accordingly, the data segments that the multiple threads are responsible for downloading will be correspondingly and directly written to the target file according to the shared read-write property set in the operating system.

In step S230, the multiple threads download the data segments and write the downloaded data segments to the target file starting from the write positions.

That is, after the file pointers are set to the write positions corresponding to the start position information of the data segments to be downloaded, the multiple threads can separately download the data segments of the file to be downloaded responsible by each thread, and write the downloaded data segment to the target file starting from the write positions.

In the method for downloading files provided by the embodiment of the present disclosure, the multiple threads are respectively responsible for downloading the corresponding data segments of the file to be downloaded respectively, and write the downloaded data segments to the target file created for the file to be downloaded. Therefore, according to the embodiment of the present disclosure the problem of slow disk read-write speed resulting from massive disk resources occupied by the file merging process, download speed and download smoothness are improved, and download experience is enhanced for users.

On this basis, for the purpose of lowering the chance of damaging file caused by removing a removable device in use, the different processing should be done according to whether the storage device possesses a removable property.

Correspondingly, the method for downloading files may further include: determining whether a storage device for storing the target file is a removable device; if the storage device for storing the target file is a removable device, adding a non-buffer read-write mark for the target file; and if the storage device for storing the target file is not a removable device, adding a buffer read-write mark for the target file.

Herein, the buffer read-write mark is defined with respect to the non-buffer read-write mark, for informing the operating system to use a system buffer to optimize a read-write speed. In practice, in addition to the aforementioned distinctively adding the non-buffer read-write mark and the buffer read-write mark, a random read-write mark may be also added for the target file. It should be noted that the random read-write mark is used to inform the operating system to optimize buffering. It can be seen that by distinguishing storage devices according to their removability properties and adding marks indicating various downloading and storage ways for the target file, the chance of damaging files caused by removing the removable devices is reduced.

### Embodiment 2

FIG. 3 is a logic block diagram illustrating an apparatus for downloading files according to a second embodiment of the present disclosure, which can be used to implement the method of the embodiment shown in FIG. 2.

Referring to FIG. 3, the apparatus for downloading files includes a file assignment module 310, a pointer setting module 320 and a file downloading module 330. Wherein, the file assignment module 310, the pointer setting module 320 and the file downloading module 330 are connected sequentially.

The file assignment module 310 is configured to create a target file for a file to be downloaded, to divide the file to be downloaded into data segments and to assign multiple threads to download the data segments, wherein each data segment has start position information.

According to a preferred embodiment of the present disclosure, the file assignment module 310 is further configured to set the size of the created target file to be the same as that of the file to be downloaded.

The pointer setting module 320 is configured to open the target file for the multiple threads, and to set file pointers to write positions corresponding to the start position information of the data segments that the multiple threads are respectively responsible for downloading.

Further, the pointer setting module 320 is further configured to open the target file in a shared read-write manner, enabling the multiple threads to access the target file simultaneously.

The file downloading module 330 is configured to download the data segments and write the downloaded data segments to the target file starting from the write positions for the multiple threads.

According to the apparatus for downloading files provided by the embodiment of the present disclosure, multiple threads are responsible for downloading corresponding data segments of the file to be downloaded respectively, and writing the downloaded data segments to the target file created for the file to be downloaded. Compared with the prior art, the processing of merging file is spared, so that the download processing is faster and smoother, thereby improving download experience for users.

In order to reduce the probability of damaging files caused by removing the removable devices, the apparatus for downloading files can further include:

a device type determining module (not shown in FIG. 3), configured to determine whether a storage device for storing the target file is a removable device; and

a file marking module (not shown in FIG. 3), configured to, add a non-buffer read-write mark for the target file, if the storage device for storing the target file is a removable device; and add a buffer read-write mark for the target file, if the storage device for storing the target file is not a removable device.

Thus, by distinguishing storage device according to their removability properties and adding a mark indicating various downloading and storage ways for the target file, the probability of damaging files caused by removing the removable devices is reduced.

### Embodiment 3

FIG. 4 is a structural diagram illustrating an electronic device according to a third embodiment of the present disclosure. Particular embodiments of the present disclosure do not limit the particular embodying form of the electronic device. Referring to FIG. 4, the electronic device 400 may include a processor 410, a communication interface 420, a memory 430 and a communication bus 440.

Herein, the processor 410, the communication interface 420 and the memory 430 perform communication with one another through the communication bus 440.

The communication interface 420 is adapted to communicate with other networking units.

The processor 410 is adapted to execute a program 432, for performing corresponding steps described in the above embodiments for the method in particular.

Specifically, the program 432 can include program code, which includes computer executable instructions.

The processor 410 may be a central processing unit (CPU), or an Application Specific Integrated Circuit (ASIC), or one or more integrated circuits configured implementing the embodiments of the present disclosure.

The memory 430 is adapted to store the program 432. The memory 430 may contain a high speed RAM (randomly accessed memory) memory or may contain a non-volatile memory, such as at least one disk memory. The program 432 is specifically configured to enable the electronic device 400 to perform the operations below: creating a target file for a file to be downloaded, dividing the file to be downloaded into data segments and assigning multiple threads to download the data segments, wherein each data segment has start position information; opening the target file by the multiple threads, and setting file pointers to write positions corresponding to the start position information of the data segments that the threads are respectively responsible for downloading; and downloading the data segments and writing the downloaded data segments to the target file starting from the write positions by the multiple threads.

In a particular embodying mode, the program 432 may also be configured to enable the electronic device 400 to perform the operations below: determining whether a storage device for storing the target file is a removable device; if the storage device for storing the target file is a removable device, adding a non-buffer read-write mark for the target file; and if the storage device for storing the target file is not a removable device, adding a buffer read-write mark for the target file.

In a particular embodying mode, the program 432 may also be configured to enable the electronic device 400 to perform the operations below: setting the size of the created target file to be the same as that of the file to be downloaded.

In a particular embodying mode, the program 432 may also be configured to enable the electronic device 400 to perform the operations below: opening the target file in a shared read-write manner.

Descriptions on corresponding steps and units in the above embodiments may be referred to for particular implementations of the operations performed in the program 432, and are not repeatedly described herein. Those skilled in the art can clearly appreciate that for convenience and conciseness, the particular processing in the embodiment for the method can be referred to for the corresponding processing of the apparatus and modules described above, and is not repeatedly described herein.

In addition, the embodiments of the present disclosure also provide a computer program, which includes computer executable code. When the computer executable code is executed on the electronic device, the electronic device is caused to perform the method for downloading files described in any one of the embodiments of the multiple methods described above.

Also, the embodiments of the present disclosure also provide a computer readable medium, on which the above computer program is stored.

By the technique schemes provided by the embodiments of the present disclosure, the multiple threads are respectively responsible for downloading corresponding data segments of the file to be downloaded respectively, and write the downloaded data segments to the target file created for the file to be downloaded. Compared with the prior art, the processing of merging a file is spared, so that the download processing is faster and smoother, thereby improving download experience for users. Furthermore, by distinguishing whether the storage device possesses removability property, the chance of damaging files when removing the removability device is reduced.

In addition, typically, the electronic device described in the present disclosure can be a variety of portable terminal device, such as a mobile phone, a personal digital assistant, etc. Therefore, the scope of the present disclosure should not be construed to limit to certain particular types of electronic devices.

Also, the method addressed in the present disclosure can also be implemented by a computer program executed by a CPU, which can be stored in a computer readable medium. When the computer program is executed by its CPU, the functions defined above in the method of the present disclosure are performed.

Also, steps in the above method and system units may be implemented by a controller and a computer readable medium for storing a computer program causing the controller to execute the above steps or unit functions.

Also, it is to be understood, the computer readable medium mentioned herein (e.g. memory) can be a volatile memory or a non-volatile memory, or can include both. As an example, but not limited to, the non-volatile memory can include a read-only memory (ROM), a programmable ROM (PROM), an electrically programmable ROM (EPROM), an electrically erasable programmable ROM (EEPROM), or a flash memory. The volatile memory can include randomly accessible memory, which serves as external high speed cashing memory. As an example, but not limited to, the RAM can be obtained in various ways, such as synchronous RAM (SRAM), dynamic RAM (DRAM), synchronous DRAM (SDRAM), double data rate SDRAM (DDR SDRAM), enhanced SDRAM (ESDRAM), synchronous link DRAM (SLDRAM) and direct Rambus RAM (DRRAM). The storage devices according to aspects of the present disclosure can include these memories and any memories of other suitable types, but not limited thereto.

Those skilled in the art should also appreciate that various exemplary logic blocks, modules, circuits and algorithmic steps incorporated in the present disclosure can be implemented as electronic hardware, computer software or both. For clear explanation of such interchangeability between hardware and software, general descriptions have been given on functions of various exemplary components, blocks, module, circuits and steps. Whether such functions are implemented in software or hardware depends on particular implementation and design constraints imposed on the entire system. Those skilled in the art can implement such functions with respect to each particular disclosure and in a variety of manners, but such implementation decision cannot be construed as out of the scope of the present disclosure.

Various exemplary logic blocks, modules, circuits and algorithmic steps incorporated in the present disclosure can be designed to be implemented or performed by a component(s) listed below for executing the functions described herein: a general processor, a digital signal processor (DSP), an application specific integrated circuit (ASIC), a field programmable gate array (FPGA) or other programmable logic device, split gate or transistor logic, separate hardware components, or any combination of these components. A general processor can be a microprocessor, but alternatively, can be any traditional processors, controllers, microcontrollers, or state machines. Processors can also be implemented as a combination of a computing device, for example, a combination of multiple microprocessors and DSP, multiple microprocessors, one or more microprocessor in combination with a DSP core, or any other such configuration.

Various exemplary steps of the method or algorithm incorporated in the present disclosure can be directly incorporated in hardware, software module executed by the processor or the combination of the two. The software modules can reside in a RAM, a flash memory, a ROM, an EPROM, an EEPROM, a register, hard disk, removable disk, CD-ROM or storage medium in any other known form in the art. An exemplary storage medium is coupled into a processor, enabling the processor to read information from the storage medium or to write information into the storage medium. In an alternative mode, the storage medium can be incorporated with the processor. The processor and the storage medium may reside in an ASIC, which may reside in a user terminal. In an alternative mode, the processor and the storage medium may reside in the user terminal as separate components.

In one of more exemplary designs, these functions can be implemented in hardware, software, firmware or any combination of the above. If the functions are implemented in software, they can be stored in a computer readable medium or transmitted through a computer readable medium as one or more instructions or code. Said computer readable medium include computer storage medium or transmission medium which includes any medium that facilitates transmission of a computer program from one location to another. Said storage medium may be any usable medium that are accessible by a general purpose computer or dedicated computer. As an example, but not limited to, said computer readable medium can include RAM, ROM, EEPROM, CD-ROM or any other optic storage device, disk storage device or any other magnetic storage device, or may be any other medium for carrying or storing program code in the form of instructions or data structures and accessible by general purpose computers or dedicated computers or general purpose or special use processors. Also, any connections can be suitably called computer readable medium. For example, if software is transmitted from a website, a server or any other remote source via a coaxial cable, optic cable, twisted-pair cable, digital subscriber line (DSL) or wireless technology such as infrared, radio and microwave, then said coaxial cable, optic cable, twisted-pair cable, digital subscriber line (DSL) or wireless technology such as infrared, radio and microwave all fall in the definition of the medium. As used herein, magnetic disks and optic disks include compact discs (CD), laser discs, optic discs, digital versatile discs, floppy disks and blue-ray discs, wherein magnetic disks typically reproduce data magnetically while optic disks reproduce data optically using laser. The combination of the above should also fall in the scope of a computer readable medium.

Exemplary embodiments are given above, but it should be noted that these are merely disclosed exemplary embodiments. On the premise of not violating the scope of the present disclosure defined in the claims, various change and modifications can be done. The functions, steps and/or actions defined in the method claims of the embodiments do not necessarily be performed in any particular order. Also, although elements of the present disclosure may be described or claimed in a singular form, said elements can be seen as plural, unless specifically limited to being singular.

It should be noted, unless otherwise supported clearly in the context, a singular form “a” (“a”, “an”, “the”) is intended in included plural forms. It should be noted that the phrasing of “and/or” in this text refers to inclusion of any one of one or more items associated listed or a combination of all of the items.

The above reference numerals in the embodiments of the present disclosure are merely for description purpose and do not indicate the advantages or disadvantages of the embodiments.

Those skilled in the art can appreciate that all or parts of the steps in the above embodiments can be completed via hardware or through programs instructing hardware. Such programs can be stored in a computer readable storage medium, which may be read-only storage, magnetic disks or optical disks, etc.

The above are merely particular embodying modes of the present disclosure, but the protection scope of the present disclosure is not limited thereto. Any one skilled in the art can readily conceive of changes or substitutions in the technical scope as disclosed in the present disclosure, which changes or substitutions should all fall in the protection scope of the present disclosure.

What is claimed is:

1. A method for downloading files, comprising:
at an electronic device:
creating a target file for a file to be downloaded, dividing the file to be downloaded into data segments and assigning multiple threads to download the data segments, wherein each data segment has start position information;
opening the target file by the multiple threads, and setting file pointers to write positions corresponding to the start position information of the data segments the threads are respectively responsible for downloading; and
downloading the data segments and writing the downloaded data segments to the target file starting from the write positions by the multiple threads.

2. The method according to claim 1, wherein the creating the target file for the file to be downloaded further comprises:
setting the size of the created target file to be the same as that of the file to be downloaded.

3. The method according to claim 1, wherein the opening the target file further comprises:
opening the target file in a shared read-write manner.

4. The method according to claim 1, wherein the method further comprises:
determining whether a storage device for storing the target file is a removable device;
if the storage device for storing the target file is a removable device, adding a non-buffer read-write mark for the target file; and
if the storage device for storing the target file is not a removable device, adding a buffer read-write mark for the target file.

5. The method according to claim 4, wherein the creating the target file for the file to be downloaded further comprises:
setting the size of the created target file to be the same as that of the file to be downloaded.

6. The method according to claim 4, wherein the opening the target file further comprises:
opening the target file in a shared read-write manner.

7. An electronic device, comprising:
at least one processor; and
a memory communicably connected with the at least one processor and for storing instructions executable by the at least one processor,
wherein execution of the instructions by the at least one processor causes the at least one processor to:
create a target file for a file to be downloaded, divide the file to be downloaded into data segments and assign multiple threads to download the data segments, wherein each data segment has start position information;
open the target file by the multiple threads, and set file pointers to write positions corresponding to the start position information of the data segments the threads are respectively responsible for downloading; and
download the data segments and write the downloaded data segments to the target file starting from the write positions by the multiple threads.

8. The electronic device according to claim 7, wherein the creating the target file for the file to be downloaded further comprises:
setting the size of the created target file to be the same as that of the file to be downloaded.

9. The electronic device according to claim 7, wherein the opening the target file further comprises:
opening the target file in a shared read-write manner.

10. The electronic device according to claim 7, wherein the processor is further configured to:
determine whether a storage device for storing the target file is a removable device;
if the storage device for storing the target file is a removable device, add a non-buffer read-write mark for the target file; and
if the storage device for storing the target file is not a removable device, add a buffer read-write mark for the target file.

11. The electronic device according to claim 10, wherein the creating the target file for the file to be downloaded further comprises:
setting the size of the created target file to be the same as that of the file to be downloaded.

12. The electronic device according to claim 10, wherein the opening the target file further comprises:
opening the target file in a shared read-write manner.

13. A non-transitory computer-readable storage medium storing executable instructions that, when executed by an electronic device, cause the electronic device to:
create a target file for a file to be downloaded, divide the file to be downloaded into data segments and assign multiple threads to download the data segments, wherein each data segment has start position information;
open the target file by the multiple threads, and set file pointers to write positions corresponding to the start position information of the data segments the threads are respectively responsible for downloading; and
download the data segments and write the downloaded data segments to the target file starting from the write positions by the multiple threads.

14. The non-transitory computer-readable storage medium according to claim 13, wherein the non-transitory computer-readable storage medium further causes the electronic device to, when the creating the target file for the file to be downloaded, set the size of the created target file to be the same as that of the file to be downloaded.

15. The non-transitory computer-readable storage medium according to claim 13, wherein the non-transitory computer-readable storage medium further causes the electronic device to, when opening the target file, open the target file in a shared read-write manner.

16. The non-transitory computer-readable storage medium according to claim 13, wherein the non-transitory computer-readable storage medium further causes the electronic device to:
determine whether a storage device for storing the target file is a removable device;
if the storage device for storing the target file is a removable device, add a non-buffer read-write mark for the target file; and
if the storage device for storing the target file is not a removable device, add a buffer read-write mark for the target file.

17. The non-transitory computer-readable storage medium according to claim 16, wherein the non-transitory computer-readable storage medium further causes the electronic device to, when the creating the target file for the file to be downloaded, set the size of the created target file to be the same as that of the file to be downloaded.

18. The non-transitory computer-readable storage medium according to claim 16, wherein the non-transitory computer-readable storage medium further causes the electronic device to, when opening the target file, open the target file in a shared read-write manner.
